(19) United States
(12) Patent Application Publication
(10) Pub. No.: US 2026/0001445 A1
(43) Pub. Date: Jan. 1, 2026

(54) METHOD FOR CONTROLLING BATTERY FOR AN ELECTRIC VEHICLE, CONTROLLER, AND ELECTRIC VEHICLE

(71) Applicants: HYUNDAI MOTOR COMPANY, SEOUL (KR); KIA CORPORATION, SEOUL (KR)

(72) Inventor: Won Jae Lee, Hwaseong-si (KR)

(73) Assignees: HYUNDAI MOTOR COMPANY, SEOUL (KR); KIA CORPORATION, SEOUL (KR)

(21) Appl. No.: 18/970,163

(22) Filed: Dec. 5, 2024

(30) Foreign Application Priority Data
Jul. 1, 2024 (KR) 10-2024-0086208

(51) Int. Cl. B60L 58/20; B60L 15/20; B60L 53/57; G07C 5/02; H01M 10/44

(52) U.S. Cl. CPC B60L 58/20; B60L 15/20; B60L 53/57; H01M 10/441; B60L 2260/20; G07C 5/02; H01M 2220/20

(57) ABSTRACT

A method of controlling a battery of an electric vehicle including a plurality of wheels, a driving motor supplying power to the plurality of wheels, and a controller controlling power supply to the driving motor and/or charging by the driving motor, includes the controller dividing an operation section into a plurality of areas based on reference data including learning data obtained during driving of the electric vehicle, selecting either a first battery or a second battery based on the operation section in which the operation point of the driving motor is among the plurality of operation sections, and controlling the power supply and/or the charging using the selected battery.

### CROSS REFERENCE TO RELATED APPLICATIONS

The present application claims priority to Korean Patent Application No. 10-2024-0086208, filed on Jul. 1, 2024, the entire contents of which is incorporated herein for all purposes by this reference.

### TECHNICAL FIELD

The present disclosure relates to a method of controlling a battery of an electric vehicle, a controller for the electric vehicle, and the electric vehicle.

### BACKGROUND

The statements in this section merely provide background information related to the present disclosure and may not constitute prior art.

Generally, electric vehicles are driven with their wheels driven by a driving force of a driving motor.

In addition, it is common for a high voltage battery to be fixed to and mounted on the vehicle to supply power to the driving motor.

The driving motor may be an AC motor, so an inverter may be arranged between the battery and the driving motor.

When the battery of an electric vehicle requires charging according to its state of charge (SOC), it is charged by receiving external power through an on-board charger (OBC).

The time required for charging an electric vehicle is determined depending on the charging method, and there are two main types of charging: slow charging and fast charging.

By virtue of continuous research and development on batteries, in recent days, driving range per charge has been significantly improved.

However, a single battery may still be insufficient, so an alternative is needed.

The information included in this Background of the present disclosure section is only for enhancement of understanding of the general background of the present disclosure and may not be taken as an acknowledgement or any form of suggestion that this information forms the prior art already known to a person skilled in the art.

### SUMMARY

One embodiment of the present disclosure is aimed at resolving the above-described existing problems.

One embodiment of the present disclosure is aimed at providing a strategy for efficiently operating a dual battery based on an operation point of a driving motor by dividing an operation section into multiple areas.

One embodiment of the present disclosure is aimed at providing a strategy for efficiently operating a dual battery based on a driver's driving habits, which has been learned.

One embodiment of the present disclosure is aimed at proposing a new concept of using a second high voltage battery that can be attached to and detached from a power system of an electric vehicle as needed in addition to a first high voltage battery that has been already installed in the electric vehicle.

One embodiment of the present disclosure is aimed at providing a method of controlling a battery of an electric vehicle suitable for a low power mode.

An embodiment of the present disclosure provides a method of controlling a battery of a vehicle including a plurality of wheels, a driving motor configured to supply a driving force to the plurality of wheels, and a controller configured to control power supply to the driving motor or charging by the driving motor, the method comprising determining, by the controller, a plurality of operation sections based on reference data including learning data obtained during driving of the vehicle, selecting, by the controller, one among a first battery or a second battery based on an operation section in which an operation point of the driving motor is among the plurality of operation sections, and controlling the power supply or the charging using the selected battery.

In at least one embodiment of the present disclosure, the plurality of operation sections may be set according to at least one of an equal power reference line, an equal APS reference line, and an RPM reference line based on the reference data.

In at least one embodiment of the present disclosure, the plurality of operation sections may include at least two of a first discharge operation section below a discharge RPM reference line and a discharge equal APS reference line, a second discharge operation section surrounded by a discharge equal power reference line, the discharge equal APS reference line, and a predetermined maximum discharge torque line, a third discharge operation section determined as above the equal power reference line, and a fourth discharge operation section determined as above the discharge RPM reference line and below the discharge equal power reference line, or include at least two of: a first charging operation section below a charging RPM reference line and above a charging equal APS reference line, a second charging operation section surrounded by a charging equal power reference line, the charging equal APS reference line, and a predetermined maximum charging torque line, a third charging operation section determined as below the charging equal power reference line, and a fourth charging operation section determined as above the charging RPM reference line and the charging equal power reference line.

In at least one embodiment of the present disclosure, the learning data may include power data, torque data, and RPM data.

In at least one embodiment of the present disclosure, the power data may include discharge power data and/or charging power data, the torque data may include discharge torque data and/or charging torque data, and the RPM data may include discharge RPM data and/or charging RPM data.

In at least one embodiment of the present disclosure, the discharge power data may include a first discharge power and a second discharge power, the charging power data may include a first charging power and a second charging power, the discharge torque data may include a first discharge torque and a second discharge torque, the charging torque data may include a first charging torque and a second charging torque, the discharge RPM data may include a first discharge RPM and a second discharge RPM, or the charging RPM data may include a first charging RPM and a second charging RPM.

In at least one embodiment of the present disclosure, when a general mode has been set as a driving mode, the selecting of one battery may include at least one of: selecting a battery of a higher voltage among the first battery and the second battery as the one battery when the current operation point is in the first discharge operation section or the second discharge operation section and a required power of the operation point is greater than the first discharge power or RPM of the operation point is greater than the first discharge RPM, selecting a battery of a lower voltage among the first battery and the second battery as the one battery when the current operation point is in the third discharge operation section or the fourth discharge operation section and the required power is less than the second discharge power and the RPM is less than the second discharge RPM, selecting the battery of the higher voltage as the one battery when the current operation point is in the first charging operation section or the second charging operation section and the required power is less than the first charging power or the RPM is greater than the first charging RPM, and selecting the battery of the lower voltage as the one battery when the current operation point is in the third charging operation section or the fourth charging operation section and the required power is greater than the second charging power and the RPM is less than the second charging RPM.

In at least one embodiment of the present disclosure, the general mode may include at least one of a normal mode, a comfort mode, of an eco mode.

In at least one embodiment of the present disclosure, when a performance mode has been set as a driving mode, the selecting of one battery may include at least one of selecting a battery of a higher voltage among the first battery and the second battery as the one battery when the current operation point is in the first discharge operation section or the fourth discharge operation section and a required power of the operation point is greater than the first discharge power or a required torque of the operation point is greater than the first discharge torque; selecting a battery of a lower voltage among the first battery and the second battery as the one battery when the current operation point is in the second discharge operation section or the third discharge operation section and the required power is less than the second discharge power and the required torque is less than the second discharge RPM selecting the battery of the higher voltage as the one battery when the current operation point is in the first charging operation section or the fourth charging operation section and the required power is less than the first charging power or the required torque is less than the first charging torque; and selecting the battery of the lower voltage as the one battery when the current operation point is in the second charging operation section or the third charging operation section and the required power is greater than the second charging power and the required torque is greater than the second charging torque.

In at least one embodiment of the present disclosure, the performance mode may include at least one of a sports mode or a track mode.

In at least one embodiment of the present disclosure, the method may further comprise obtaining data on power, torque and RPM for a predetermined driving distance for each driving situation and determining averages thereof, repeatedly in a predetermined number of times, applying a standardized normal distribution for the averages, and determining based on a set probability, at least one set of: the first discharge power and the second discharge power; the first charging power and the second charging power, the first discharge torque and the second discharge torque, the first charging torque and the second charging torque, the first discharge RPM and the second discharge RPM; or the first charging RPM and the second charging RPM.

In at least one embodiment of the present disclosure, the method may further comprise determining a set of the first discharge power and the second discharge power or the first charging power and the second charging power based on an average and a standard deviation of data on power among the averages, determining the discharge torque first and the second discharge torque or the first charging torque and the second charging torque based on an average and a standard deviation of data on torque among the averages, or determining the first discharge RPM and the second discharge RPM or the first charging RPM and the second charging RPM based on an average and a standard deviation of data on RPM among the averages.

In at least one embodiment of the present disclosure, the method may further comprise determining that the second battery has been detachably connected and added to a power system including the first battery.

Meanwhile, according to an embodiment of the present disclosure, there is provided a vehicle controller comprising a memory storing instructions; and one or more processors configured to execute the instructions, wherein the instructions, when executed by the one or more processors, cause the controller to determine a plurality of operation sections based on reference data including learning data obtained during driving of the vehicle, select one among a first battery or a second battery based on an operation section in which an operation point of the driving motor is among the plurality of operation sections, and control the power supply or the charging using the selected battery.

In addition, according to an embodiment of the present disclosure, there is provided a vehicle including a plurality of wheels; a driving motor supplying a driving force to the plurality of wheels, and a controller including a memory storing instructions and one or more processors configured to execute the instructions to control power supply to the driving motor or charging by the driving motor, wherein the instructions, when executed by the one or more processors, cause the controller to determine a plurality of operation sections based on reference data including learning data obtained during driving of the vehicle; select one among a first battery or a second battery based on an operation section in which an operation point of the driving motor is among the plurality of operation sections, and control the power supply or the charging using the selected battery.

In at least one embodiment of the present disclosure, the plurality of operation sections may be set according to at least one of an equal power reference line, an equal APS reference line, and an RPM reference line based on the reference data.

In at least one embodiment of the present disclosure, the plurality of operation sections may include at least two of a first discharge operation section below a discharge RPM reference line and a discharge equal APS reference line, a second discharge operation section surrounded by a discharge equal power reference line, the discharge equal APS reference line, and a predetermined maximum discharge torque line; a third discharge operation section determined as above the equal power reference line, and a fourth discharge operation section determined as above the discharge RPM reference line and below the discharge equal power reference line, or include at least two of a first charging operation section below a charging RPM reference line and above a charging equal APS reference line, a second charging operation section surrounded by a charging equal power reference line, the charging equal APS reference line, and a predetermined maximum charging torque line, a third charging operation section determined as below the charging equal power reference line, and a fourth charging operation section determined as above the charging RPM reference line and the charging equal power reference line.

In at least one embodiment of the present disclosure, the learning data may include power data, torque data, and RPM data.

In at least one embodiment of the present disclosure, the power data may include discharge power data or charging power data, the torque data may include discharge torque data or charging torque data, and the RPM data may include discharge RPM data or charging RPM data.

In at least one embodiment of the present disclosure, the discharge power data may include a first discharge power and a second discharge power, the charging power data may include a first charging power and a second charging power, the discharge torque data may include a first discharge torque and a second discharge torque, the charging torque data may include a first charging torque and a second charging torque, the discharge RPM data may include a first discharge RPM and a second discharge RPM, or the charging RPM data may include a first charging RPM and a second charging RPM.

According to one embodiment of the present disclosure, it may be possible to achieve a strategy for efficiently operating a dual battery based on an operation point of a driving motor by dividing an operation section into multiple areas.

According to one embodiment of the present disclosure, it may be possible to achieve a strategy for efficiently operating a dual battery based on a driver's driving habits, which has been learned.

According to one embodiment of the present disclosure, it may be possible to attach a second high voltage battery to a power system of an electric vehicle and detach it therefrom as needed in addition to a first high voltage battery that has been already installed in the electric vehicle, thereby extending a driving range of the electric vehicle.

According to one embodiment of the present disclosure, it may be possible to efficiently operate a dual battery by varying the reference point for switching the use of the dual battery according to a driver's driving habits, thereby improving SOH of the battery by enhancing the balance of SOC of the battery.

According to one embodiment of the present disclosure, it may be possible to perform conditioning of either battery of a dual battery system suitable for the current operation point rather than conditioning of both batteries by using a battery having a lower voltage in a driving situation with a low current and a battery having a higher voltage in a driving situation with a high current, thereby improving energy efficiency.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE FIGURES

FIG. 1 shows a power system of a first mobility device according to an embodiment of the present disclosure.

FIG. 2 shows how a second mobility device is connected to the first mobility device according to an embodiment of the present disclosure.

FIGS. 3, 4, and 5 illustrate a control process according to an embodiment of the present disclosure.

FIG. 6 shows an example of specifications of a first high voltage battery and a second high voltage battery.

FIG. 7 shows how an operation section is divided into multiple areas on a torque-RPM map.

FIG. 8 illustrates an equal power reference line, an equal APS reference line, and an RPM reference line based on learning data.

FIG. 9 illustrates the process of obtaining learning data.

FIGS. 10, 11, and 12 illustrate data obtained in the process of obtaining the learning data.

FIG. 13 shows an example of a control simulation according to an embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes, will be determined in part by the particularly intended application and use environment.

In the figures, the same reference numerals refer to the same or equivalent parts of the present disclosure throughout the several figures of the drawing.

### DETAILED DESCRIPTION

Because various changes can be made to the present disclosure and a range of embodiments can be made for the present disclosure, specific embodiments will be illustrated and described in the drawings. However, this is not intended to limit the present disclosure to the specific embodiments, and it should be understood that the present disclosure includes all changes, equivalents, and substitutes within the technology and the scope of the present disclosure.

The terms “module” and “unit” used in the present disclosure are merely used to distinguish the names of components, and should not be interpreted as assuming that the components have been physically or chemically separated or can be so separated.

Terms containing ordinal numbers such as “first” and “second” may be used to describe various components, but the components are not limited by the terms. The above-mentioned terms can be used only as names to distinguish one component from another component, and the order therebetween can be determined by the context in the descriptions thereof, not by such names.

The expression “and/or” is used to include all possible combinations of multiple items being addressed. For example, by “A and/or B,” all three possible combinations are meant: “A,” “B,” and “A and B.”

When a component is said to be “coupled” or “connected” to another component, it means that the component may be directly coupled or connected to the other component or there may be other components therebetween.

The terms used herein are only used to describe specific embodiments and are not intended to limit the present disclosure. Expressions in the singular form include the meaning of the plural form unless they clearly mean otherwise in the context. In the present disclosure, expressions such as “comprise” or “have” are intended to indicate the presence of features, numbers, steps, operations, components, parts, or combinations thereof described herein, and should not be understood as precluding the possibility of the presence or the addition of one or more other features, numbers, steps, operations, components, parts, or combinations thereof.

Unless otherwise defined, all terms used herein, including technical or scientific terms, have meanings commonly understood by a person having ordinary skill in the technical field to which the present disclosure pertains. Terms defined in commonly used dictionaries should be interpreted as having meanings consistent with the meanings they have in the context of the relevant technology, and should not be interpreted in an ideal or overly formal sense unless explicitly defined in the present disclosure.

In addition, a unit, a control unit, a control device, or a controller is only a term widely used to name devices for controlling a certain function, and do not mean a generic function unit. For example, devices with these names may include a communication device that communicates with other controllers or sensors to control a certain function, a computer-readable recording medium that stores an operating system, logic instructions, input/output information, etc., and one or more processors that perform operations of determination, calculation, making decisions, etc. required to control the function.

Meanwhile, the processor may include a semiconductor integrated circuit and/or electronic devices that carry out operations of at least one of comparison, determination, calculation, and making decisions to perform a programmed function. For example, the processor may be any one or a combination of a computer, a microprocessor, a CPU, an ASIC, and an electronic circuit such as circuitry and logic circuits.

Examples of a computer-readable recording medium (or simply called a memory) may include all types of storage devices for storing data that can be read by a computer system. For example, they may include at least one of a memory such as a flash memory, a hard disk, a micro memory, and a card memory, e.g., a secure digital card (SD card) or an eXtream digital card (XD card), and a memory such as a random access memory (RAM), a static ram (SRAM), a read-only memory (ROM), a programmable ROM (PROM), an electrically erasable PROM (EEPROM), a magnetic RAM (MRAM), a magnetic disk, and an optical disk.

Such a recording medium may be electrically connected to the processor, and the processor may load and write data from the recording medium. The recording medium and the processor may be integrated or may be physically separate.

Hereinafter, the attached drawings will be briefly described, and, with reference to the drawings, the embodiments of the present disclosure will be described in detail.

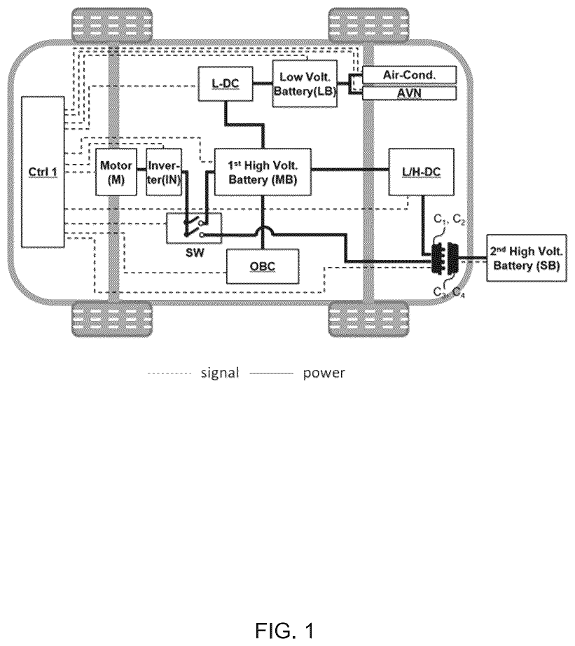

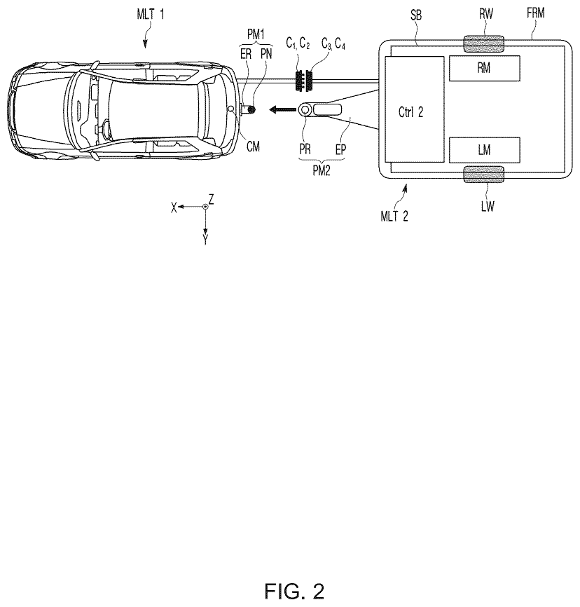

FIG. 1 conceptually shows the power system of a first mobility device MLT 1 (e.g., an electric vehicle) according to an embodiment of the present disclosure, and FIG. 2 shows how a second mobility device MLT 2 is connected to the first mobility device MLT 1.

With reference to FIGS. 1 and 2, the structure of each of the first mobility device MLT 1 and the second mobility device MLT 2 according to an embodiment of the present disclosure will be described.

As shown in FIG. 1, the first mobility device MLT 1 according to an embodiment of the present disclosure is, for example, an electric vehicle, and may include a first driving motor M, an inverter IN, a first high voltage battery MB, an on-board charger OBC, a first DC/DC converter L-DC, a low voltage battery LB, an air-conditioning device Air-cond. and an audio video navigation AVN, which operate at low voltage, a second DC/DC converter L/H-DC, a switch SW, and a controller (hereinafter, referred to as a “first controller”).

The first driving motor M may provide a driving force to the wheels of a vehicle and may be an AC motor for example.

The inverter IN may convert a direct current power supplied to the first driving motor M into alternating current.

The first high voltage battery MB may be fixed to and installed in the body of the first mobility device MLT 1, for example, under the floor of the passenger compartment.

The main function of the first high voltage battery MB may be to supply electric power to the first driving motor M and can be charged with the on-board charger OBC.

In addition, the first high voltage battery MB may be connected to the low voltage battery LB through the first DC/DC converter L-DC to charge the low voltage battery LB.

For charging the low voltage battery LB, the first DC/DC converter L-DC may be a low-voltage DC-DC converter LDC.

The low voltage battery LB may be, for example, a 12 V or 24 V battery, and may supply electric power to electrical devices in a vehicle, such as an air-conditioning device and an AVN, which operate at low voltage.

A second high voltage battery SB shown in FIG. 1 may be installed in the second mobility device MLT 2 and may be mechanically connected through a connection mechanism as described below, but is not necessarily limited thereto. For example, the second high voltage battery SB may also be removably installed in the first mobility device to be mechanically connected.

The second high voltage battery SB may be additionally connected to a vehicle's power system including the first high voltage battery MB. That is, the second high voltage battery SB may be detachably and electrically connected to the power system by wire (or wirelessly within possible range) in a manner that the absence of the second high voltage battery SB has no effect on the operation of the power system (power supply to electronics, a driving motor, etc. of a vehicle).

In addition, the second high voltage battery SB may be referred to as a replaceable battery, an auxiliary battery, an extended battery, or a secondary battery, but this is only to distinguish the second high voltage battery SB from the first high voltage battery MB. In other words, anything regarding the second high voltage battery SB, such as the functions, the features, its own mechanical/electrical/chemical structure or that in relationship with other objects (including the first high voltage battery MB, a host vehicle, etc.), the type of battery (including a packaging method and the type of anode material, cathode material, separator, etc.), and the charging method, is not limited by how it is called.

It may be possible for the second high voltage battery SB to communicate with a first controller Ctrl 1 of the first mobility device MLT 1 or a battery management system (BMS) of the first high voltage battery MB, which will be described below, by wire or wirelessly, so that various sensing information (e.g., voltage, current, temperature, etc.) related to the state of charge (SoC) and the physical/electrical/chemical state of the second high voltage battery SB may be transmitted to the first controller Ctrl 1. However, not necessarily limited thereto, the above-mentioned information related to the second high voltage battery SB may also be transmitted to the first controller Ctrl 1 through a second controller Ctrl 2 of the second mobility device MLT 2, which will be described below.

According to this embodiment of the present disclosure, the high voltage battery applied to the first high voltage battery MB and the second high voltage battery SB may include, for example, a plurality of battery cells (not shown) outputting a voltage of 2.7 to 4.2 V, and a set number of battery cells may be connected in series/parallel to each other to form one module. The high voltage battery may be in the form of one or more battery modules connected to each other in series/parallel and thus packaged in one battery package to output a desired voltage, e.g., a voltage of about 400 V, about 800 V, or several kV.

The first high voltage battery MB and the second high voltage battery SB may each include the BMS.

The BMS may include a battery management unit (BMU), a cell monitoring unit (CMU), and a battery junction box (BJB).

The BMS may perform a cell balancing function to ensure the performance of the entire battery pack by maintaining the voltage of each cell constant, a SoC function to calculate the capacity of the entire battery system, control of battery cooling, charging, and discharge, etc.

The BMU may receive information on each cell from the CMU and fulfill the functions of the BMS based thereon.

For example, the BMU may include two micro control units (MCUs), and each MCU may have one CAN communication port. A CAN interface may be included for the communication with a vehicle controller, which can be said to be the upper device of the BMS, and a CAN interface may be included to collect information from the CMU, which is the lower device thereof.

The CMU may be directly attached to a battery cell and monitor voltage, current, temperature, etc. The CMU may not perform calculations related to the BMS algorithm and may only serve to monitor. One CMU may be connected to multiple battery cells, and may transmit information on each cell to the BMU through a CAN interface.

The BJB may be the mechanism for determining the pack-level of the BMS and the medium that connects the high voltage battery and drivetrain. The BJB may measure and record a battery's voltage and the current flowing in and out of the battery to accurately calculate the SoC. In addition, the BJB may perform important functions for safety, such as monitoring of insulation as well as detecting of overcurrent.

The second high voltage battery SB may be a high-voltage battery with a lower voltage than the first high voltage battery MB, and, in this case, the second DC/DC converter L/H-DC may be a DC/DC converter for voltage boosting. In contrast, the second high voltage battery SB may be a high-voltage battery with a higher voltage than the first high voltage battery MB, and, in this case, the second DC/DC converter L/H-DC may be a DC/DC converter for step-down. In addition, in this embodiment of the present disclosure, the second DC/DC converter L/H-DC may be a bidirectional converter, and it may be possible for the first high voltage battery MB and the second high voltage battery SB to charge and discharge each other.

According to this embodiment of the present disclosure, the second DC/DC converter L/H-DC may be built into the first mobility device MLT 1 in the power system, but is not limited thereto. For example, unlike this embodiment, the second DC/DC converter L/H-DC may be provided as a separate component and may be additionally and detachably connected to the power system. In addition, the second DC/DC converter L/H-DC may be built into or detachably included in the second mobility device MLT 2.

Furthermore, unlike this embodiment, the second DC/DC converter L/H-DC may not be included in another embodiment. In this case, charging and discharging may not occur between the first high voltage battery MB and the second high voltage battery SB.

According to this embodiment of the present disclosure, for the detachable and electrical connection to the power system of the second high voltage battery SB, the power system of the first mobility device MLT 1 may include first and second connectors C1 and C2, and the second high voltage battery SB may include third and fourth connectors C3 and C4.

For example, the first and second connectors C1 and C2 may be in the form of one integrated connector, and the third and fourth connectors C3 and C4 may also be in the form of one integrated connector.

The first connector C1 may be connected to the second DC/DC converter L/H-DC, and the second connector C2 may be connected to the switch SW.

Meanwhile, although not shown, it is needless to say that a connector for transmitting signals may be added to transmit various sensing and state information on the second high voltage battery SB to the controller.

The switch SW may be fixed to and electrically connected to the inverter IN, and may be turned on between the first high voltage battery MB and the second connector C2 to electrically connect the inverter IN and the first high voltage battery MB and/or the inverter IN and the second high voltage battery SB.

In addition, according to this embodiment of the present disclosure, the first controller Ctrl 1 may be the highest-level vehicle controller that controls all electric devices of the first mobility device MLT 1, but is not necessarily limited thereto. That is, for example, the first controller Ctrl 1 in FIG. 1 may be a power controller subordinate to a vehicle controller.

Furthermore, as described above, the first controller Ctrl 1 according to this embodiment may include computer-readable recording media that store operating systems, logic instructions, input/output information, etc. and one or more processors that read them and perform the operation of making determinations and decisions, doing calculations, etc. to control the functions.

The second high voltage battery SB in FIG. 1 may be installed in the second mobility device MLT 2 as shown in FIG. 2.

The second mobility device MLT 2 may include a frame FRM, a second left wheel LW installed on the left side of the frame FRM, a second right wheel RW installed on the right side of the frame FRM, a second left driving motor LM for providing a driving force to the second left wheel LW, a second right driving motor RM for providing a driving force to the second right wheel RW, and the second controller Ctrl 2.

The second high voltage battery SB may be fixed to and installed in the second mobility device MLT 2, but is not necessarily limited thereto. That is, the second high voltage battery SB may be removably installed in the second mobility device MLT 2. As a result, it may be possible to replace the second high voltage battery SB mounted on the frame FRM with the SoC of being fully discharged with a new second high voltage battery SB with the SoC of being fully charged.

When the second high voltage battery SB is fixed to and installed in the second mobility device MLT 2, the second mobility device MLT 2 may include a charging connector for charging the second high voltage battery SB.

The frame FRM may form the exterior of the second mobility device MLT 2 and may serve to accommodate other components.

The frame FRM may include a second pivot mechanism PM2 as a second connection mechanism, and the second pivot mechanism PM2 may be detachably and pivotably connected to a first pivot mechanism PM1, which is a first connection mechanism fixed to the body of the first mobility device MLT 1.

For example, the first pivot mechanism PM1 may include an extension rod ER extending rearwardly from the body of the first mobility device MLT 1 and a pivot pin PN protruding upward from an end of the extension rod ER.

In addition, the second pivot mechanism PM2 may include a triangular-shaped extension portion EP protruding forward from the frame FRM of the second mobility device MLT 2 and a pivot ring PR into which the pivot pin PN may be rotatably inserted at the end of the extension portion EP.

When the pivot pin PN is inserted into the pivot ring PR, the linear movement of the pivot pin PN may be limited, and it may only rotate in the Z-axis direction in FIG. 2. Therefore, when the second mobility device MLT 2 is pivotably connected, the linear movement of the second mobility device MLT 2 may be limited about the pivot connection point with respect to the first mobility device MLT 1, and the second mobility device MLT 2 may only rotate about the Z axis.

When driving in the forward direction, that is, in the X-axis direction, the first mobility device MLT 1 and the second mobility device MLT 2 may remain in a straight line even without separate control of the steering of the second mobility device MLT 2.

According to this embodiment, the pivot mechanisms as the first and second connection mechanisms may be included, but it is not necessarily limited thereto. For example, the first and second connection mechanisms may be well-known mechanisms that enable non-rotational connection about the Z axis.

The rotation axis of the second left driving motor LM may be connected to the second left wheel LW so that the second left driving motor LM may supply a driving force to the second left wheel LW.

In addition, the rotation axis of the second right driving motor RM may be connected to the second right wheel RW so that the second right driving motor RM may supply a driving force to the second right wheel RW.

Because the second left wheel LW and the second right wheel RW may respectively be connected to the second left driving motor LM and the second right driving motor RM, it may be possible to drive them independently of each other.

It may be possible to drive the second left driving motor LM and the second right driving motor RM in the forward and reverse directions. When they are driven in the forward direction, the second mobility device MLT 2 may travel forward, and, when they are driven in the reverse direction, it may travel backwards.

For example, the second left driving motor LM and the second right driving motor RM may each be designed as an in-wheel driving system where a driving motor is installed within a wheel, but they are not necessarily limited thereto.

In addition, unlike this embodiment, the second mobility device MLT 2 may be driven in the matter that the left and right sides of the second mobility device MLT 2 are not independent of each other and the power of one common motor is divided and transmitted to the second left wheel LW and the second right wheel RW. To this end, a differential gear may be disposed between a common second driving motor and the second left wheel LW and the second right wheel RW. That is, the power of the common second driving motor may be distributed to the second left wheel LW and the second right wheel RW by the differential gear. In this case, a torque vectoring means may be added to distribute torque among the second left wheel LW and the second right wheel RW.

Referring to FIG. 2, the second controller Ctrl 2 may control the second left driving motor LM and the second right driving motor RM to allow the second mobility device MLT 2 to travel forward and backward. In addition, when the steering of the second mobility device MLT 2 is required, the second controller Ctrl 2 may control the torque or the number of rotations of each of the second left driving motor LM and the second right driving motor RM to change the direction in which the second mobility device MLT 2 travels. That is, the driving of the second left driving motor LM and the second right driving motor RM may be separately controlled, so that it may be possible to achieve the steering of the second mobility device MLT 2 without a separate steering device.

In addition, as described above, a wired or wireless communication means for transmitting information between the connectors in FIG. 1 and the first and second mobility devices MLT 1 and MLT 2 may be included.

Meanwhile, according to this embodiment, the first controller Ctrl 1 or the second controller Ctrl 2 may include a memory and a processor. Computer instructions (programs) for performing functions of a corresponding controller may be stored in the memory, and the processor may perform the above-mentioned functions by loading the instructions from the memory and executing them.

For example, the memory may include at least one of a hard disk drive (HDD), a solid-state drive (SSD), a silicon disk drive (SDD), a ROM, a RAM, a CD-ROM, a magnetic tape, a floppy disk, and an optical data storage device.

In addition, for example, the processor may include at least one of a computer, a microprocessor, a central processing unit (CPU), an ASIC, an electric circuit, and a logic circuit.

The first and second connectors C1 and C2 of the first mobility device MLT 1 and the third and fourth connectors C3 and C4 of the second mobility device MLT 2 may be connected to each other, and the connector for transmitting signals may be connected, so that it may be possible that the first mobility device MLT 1 and the second mobility device MLT 2, that is, the first controller Ctrl 1 and the second controller Ctrl 2, communicate with each other.

When the first mobility device MLT 1 starts to drive forward with the first mobility device MLT 1 and the second mobility device MLT 2 mechanically and electrically connected to each other, according to the driving speed and the signal transmitted from the first connector C1, the second controller Ctrl 2 may control the second left driving motor LM and the second right driving motor RM to enable the second mobility device MLT 2 to drive straight ahead.

In that case, some or all of the speed, the position of the gear, the steering angle, the information on an accelerator pedal sensor (APS), and the information on a brake pedal sensor (BPS) of the first mobility device MLT 1 may be transmitted to the second mobility device MLT 2.

For example, the second controller Ctrl 2 of the second mobility device MLT 2 may determine whether the first mobility device MLT 1 is traveling forward or backward, based on some or all of the speed, the position of the gear, the information on an accelerator pedal sensor (APS), and the information on a brake pedal sensor (BPS) of the first mobility device MLT 1. However, the present disclosure is not limited thereto, and it goes without saying that the second controller Ctrl 2 of the second mobility device MLT 2 may receive the information on whether the first mobility device MLT 1 is traveling forward or backward directly from the first controller Ctrl 1.

When the first mobility device MLT 1 is traveling forward, the second controller Ctrl 2 may drive the second left driving motor LM and the second right driving motor RM in the forward direction to allow the second mobility device MLT2 to drive straight ahead. Furthermore, when the first mobility device MLT 1 is traveling backward, the second controller Ctrl 2 may drive the second left driving motor LM and the second right driving motor RM in the reverse direction to allow the second mobility device MLT2 to drive backward.

In addition, the second controller Ctrl 2 may determine how the first mobility device MLT 1 is being steered based on information on the steering angle of the first mobility device MLT 1, and may steer the second mobility device MLT 2 accordingly.

The second mobility device MLT 2 may not include a separate steering device such as a steering wheel and a steering rack, and it may be possible to steer the second mobility device MLT 2 by controlling the torque of the second left driving motor LM and the second right driving motor RM.

That is, the second controller Ctrl 2 may calculate a driving torque for driving and a steering torque for steering of each of the second left driving motor LM and the second right driving motor RM to perform the control operation.

For example, for the steering of the second mobility device MLT 2, the steering torque values of the second left driving motor LM and the second right driving motor RM according to the steering angle of the first mobility device MLT 1 may be included in a lookup table or a calculation program.

When the second mobility device MLT 2 drives straight ahead, the speed of the second mobility device MLT 2 may be controlled to be no greater than that of the first mobility device MLT 1. As a result, the pivot connection between the first mobility device MLT 1 and the second mobility device MLT 2 may be maintained at a pivot angle within a predetermined range. For example, when the speed of the second mobility device MLT 2 driving straight ahead is controlled to be no greater than that of the first mobility device MLT 1, at the pivot connection point, the pivot angle between the second mobility device MLT 2 and the first mobility device MLT 1 may be maintained at 0 degree, i.e., the angle where the first mobility device MLT 1 and the second mobility device MLT 2 are in a straight line.

When the second mobility device MLT 2 is driving forward, it may be controlled to follow the first mobility device MLT 1, so that the driving of multiple mobility devices connected to each other may be smoothly performed.

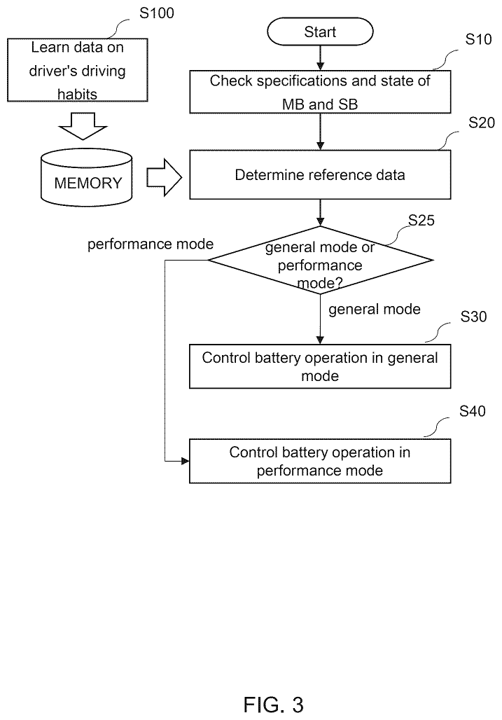

FIG. 3 is a flowchart for illustrating a control process according to an embodiment of the present disclosure, which will be described in detail below.

In this embodiment, the process of controlling a battery is described as being carried out under the control of the first controller Ctrl 1, but is not necessarily limited thereto.

The first controller Ctrl 1 may include a memory and a processor as described above. The memory may store a computer program for controlling the use of a battery according to this embodiment and, if necessary, various data required for the control process. The processor may execute the program stored in the memory, allowing the first controller Ctrl 1 to control the use of a battery based on the program.

Referring to FIG. 3, at S10, the first controller Ctrl 1 may check the specifications and state of the first high voltage battery MB and/or the second high voltage battery SB.

The specifications may include at least one of a C-rate, a nominal voltage, efficiency, a maximum current, a system voltage, and a continuous output, and the battery state may include at least one of state of health (SOH), SOC, voltage, and temperature.

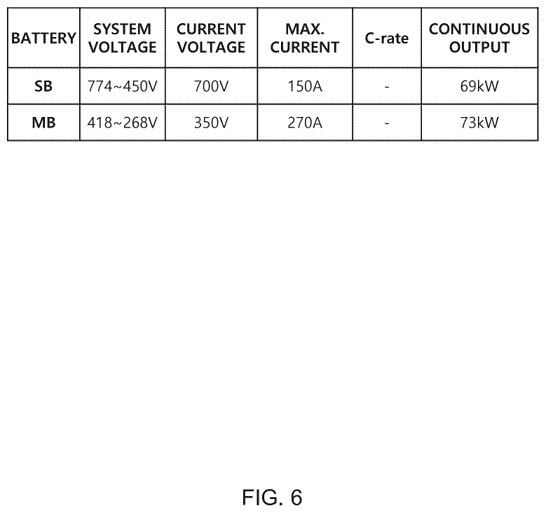

FIG. 6 shows an example of specifications of the first high voltage battery MB and the second high voltage battery SB.

Hereinafter, the description will be made on the assumption that the first high voltage battery MB is a battery with a lower voltage than the second high voltage battery SB as shown in FIG. 6, but it is needless to say that it is not limited thereto.

The first controller Ctrl 1 may determine that the first high voltage battery MB is a battery with a lower voltage based on the specifications of the first high voltage battery MB and the second high voltage battery SB.

Next, the first controller Ctrl 1 may determine a reference data at S20.

The reference data may be used to classify a plurality of operation sections, which will be described below, and may include learning data obtained through learning regarding a driver's driving habits.

When the learning data has not yet been obtained, or when it has been obtained but a driver has chosen not to use it, a system may determine a corresponding data, which will be described below, followed by a description of the learning data.

First, the first controller Ctrl 1 may determine a high-efficiency output power, an accelerator pedal sensor (APS) conversion value, and a reference RPM for the battery with a lower voltage among the first high voltage battery MB and the second high voltage battery SB, that is, the first high voltage battery MB.

For example, high-efficiency output data may be stored in the memory for each battery specification, and the first controller Ctrl 1 may select one of the data corresponding to the specifications of the first high voltage battery MB to determine the high-efficiency output power thereof.

That is, high-efficiency discharge power A and charging power B of the constant power section for the first high voltage battery MB may be determined.

In addition, the first controller Ctrl 1 may determine APS conversion values of the high-efficiency output powers A and B. It goes without saying that a torque may be determined based on the APS conversion value, and an equal APS reference line may be an equal torque reference line of a corresponding torque.

For example, a required APS value determined based on the degree to which a driver presses an accelerator pedal may be converted into a required output of the first driving motor M through an equation set in advance and stored in a memory, and the first controller Ctrl 1 may convert high-efficiency output into an APS value through the equation.

In addition, the first controller Ctrl 1 may determine a reference RPM (K) for an RPM reference line, which will be described below, based on a torque-RPM map for the first driving motor M.

For example, the RPM at the point where a maximum torque line (Tq, max) of the driving motor M and a maximum output line (Pwr, max) thereof intersect on a torque-RPM map may be determined as a reference RPM (K).

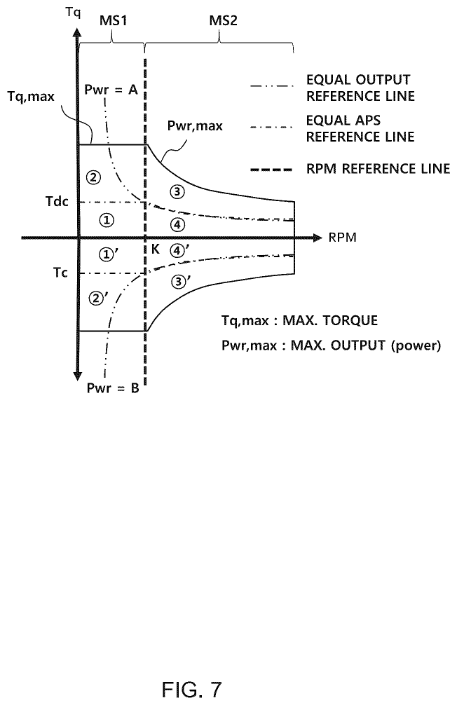

For example, on the torque-RPM map in FIG. 7, the RPM at the point where a maximum torque line (Tq=Tq,max) and a maximum output line (Pwr=Tq,max) meet may be determined as a reference RPM (K).

Furthermore, the first controller Ctrl 1 may determine a discharge torque (Tdc) and a charging torque (Tc) for the constant torque section through the following equation.

$$Tdc = A / K \\ Tc = B / K \qquad Equation 1$$

The reference data may include the high-efficiency output powers A and B and the reference RPM (K), by which the plurality of operation sections may be classified.

As shown in FIG. 7, according to the driving state, that is, the state of discharge of a battery, by an equal power reference line, an equal APS reference line, and an RPM reference line, a operation section may be divided into multiple areas: a first discharge operation section (\textcircled{1}), a second discharge operation section (\textcircled{2}), a third discharge operation section (\textcircled{3}), and a fourth discharge operation section (\textcircled{4}).

The equal power reference line may be an equal power line on a torque-RPM map for the above-described high-efficiency output of the first high voltage battery MB.

In addition, the equal APS reference line may be an equal APS line for a converted APS value of the high-efficiency output.

Furthermore, the RPM reference line may be the reference RPM line described above. In this embodiment, a reference RPM may be the boundary between an equal torque section and an equal power section on the map in FIG. 7.

Referring to FIG. 7, the first discharge operation section (\textcircled{1}) may correspond to the area below the RPM reference line and the equal APS reference line (Tq=Tdc), the second discharge operation section (\textcircled{2}) may correspond to the area surrounded by the equal power reference line (Pwr=A), the equal APS reference line (Tq=Tdc), and a maximum discharge torque line (Tq=Tq, max), which has been set, the third discharge operation section (\textcircled{3}) may correspond to the area above the equal power reference line (Pwr=A), and the fourth discharge operation section (\textcircled{4}) may correspond to the area above the RPM reference line and below the equal power reference line (Pwr=A).

Meanwhile, the torque area below 0 (zero) in FIG. 7 is for regenerative braking by the first driving motor M, i.e., charging of a battery, and may likewise be divided into four operation sections by the equal power reference line, the equal APS reference line, and the RPM reference line. In other words, as shown in FIG. 7, for the charging of the battery, a first charging operation section (\textcircled{1}′) may correspond to the area below the RPM reference line and above the equal APS reference line (Tq=Tc), a second charging operation section (\textcircled{2}′) may correspond to the area surrounded by the equal power reference line (Pwr=B), the equal APS reference line (Tq=Tc), and a maximum charging torque line (Tq=−Tq, max), which has been set, a third charging operation section (\textcircled{3}′) may correspond to the area below the equal power reference line (Pwr=B), and a fourth charging operation section (\textcircled{4}′) may correspond to the area above the RPM reference line and the equal power reference line (Pwr=B).

In FIG. 7, the operation sections for driving by the first driving motor M and the operation sections for regenerative braking by the first driving motor M may be symmetrical with respect to the RPM axis.

When a general mode, which will be described below, is set as a driving mode, as at S31, which will be described below, the first high voltage battery MB with a lower voltage may be used in the first discharge operation section (\textcircled{1}) and the second discharge operation section (\textcircled{2}), and the second high voltage battery SB with a higher voltage may be used in the third discharge operation section (\textcircled{3}) and the fourth discharge operation section (\textcircled{4}).

In addition, during regenerative braking in the general mode, the first high voltage battery MB with a lower voltage may be used in the first charging operation section (\textcircled{1}′) and the second charging operation section (\textcircled{2}′), and the second high voltage battery SB with a higher voltage may be used in the third charging operation section (\textcircled{3}′) and the fourth charging operation section (\textcircled{4}′).

Meanwhile, when a performance mode is set as a driving mode, as at S41 to S43, which will be described below, the first high voltage battery MB with a lower voltage may be used in the first discharge operation section (\textcircled{1}) and the fourth discharge operation section (\textcircled{4}), and the second high voltage battery SB with a higher voltage may be used in the second discharge operation section (\textcircled{2}) and the third discharge operation section (\textcircled{3}).

Furthermore, during regenerative braking in the performance mode, the first high voltage battery MB with a lower voltage may be used in the first charging operation section (\textcircled{1}′) and the fourth charging operation section (\textcircled{4}′), and the second high voltage battery SB with a higher voltage may be used in the second charging operation section (\textcircled{2}′) and the third charging operation section (\textcircled{3}′).

Hereinafter, the learning data will be described.

The first controller Ctrl 1 may learn data on a driver's driving habits for each driving situation using a navigation system at S100 and store the learned data in a memory.

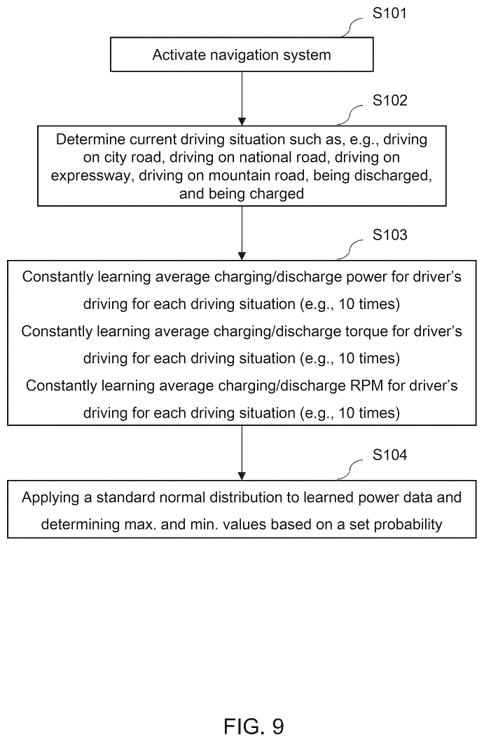

Below, this will be described in detail with reference to FIG. 9.

The first controller Ctrl 1 may activate a navigation system at S101 and determine the current driving situation based on its map data at S102.

Here, the map data may be, for example, for the navigation function of an AVN, but is not necessarily limited thereto.

A driving situation may be determined, for example, based on road types on the map data.

For example, based on the map data, driving situations may be classified according to section such as a city road section, a mountain uphill road section, a mountain downhill road section, an expressway section, and a national road section, and may be classified into discharge and charging by regenerative braking.

That is, the first controller Ctrl 1 may determine whether a vehicle is driving on a city road, a national road, an expressway, or a mountain road, and may determine whether the vehicle is discharged or charged by regenerative braking.

The city road section may include a road section defined as a city road in road information on the map data, the mountain section may include a road section defined as a mountain road in the road information on the map data, and the expressway section and the national road section may include road sections defined as an expressway and a national road, respectively, in the road information on the map data.

Hereinafter, the process of obtaining data on a driver's driving habits for each driving situation will be described.

At S103, while a host vehicle is driving a set driving distance in each driving situation depending on road type, the first controller Ctrl 1 may obtain data in real time on the power supplied to the driving motor M based on a driver's required power, i.e., the discharge power of the battery (MB or SB), to determine the average discharge power of the driving of the driving distance, which will be repeated a set number of times to obtain data on the average discharge power.

Similarly, the first controller Ctrl 1 may obtain data in real time on the charging power of the battery (MB or SB) by the power generation of the driving motor M through regenerative braking for each driving situation depending on road type to determine the average charging power of the driving of the driving distance, which will be repeated a set number of times to obtain data on the average charging power.

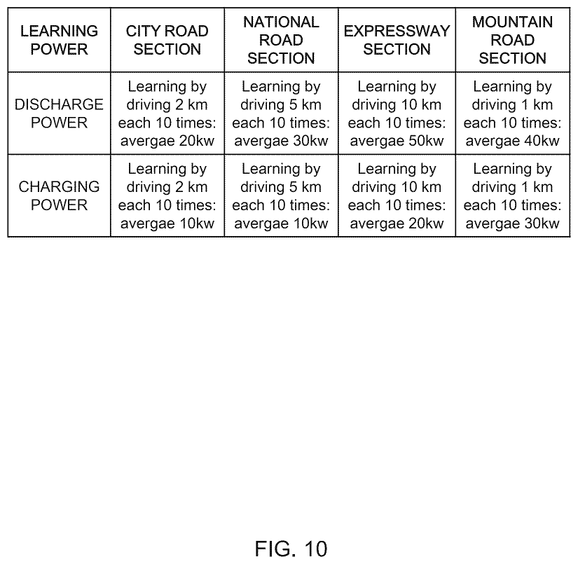

FIG. 10 shows an example of average powers obtained through learning for each driving situation, which will be described below.

First, by driving 2 km each 10 times on a city road section, an average discharge power of 20 kW may be obtained.

In addition, by driving 2 km each 10 times on the city road section, an average charging power of 10 kW may be obtained.

By driving 5 km each 10 times on a national road section, an average discharge power of 30 kW may be obtained, and, by driving 5 km each 10 times on the national road section, an average charging power of 10 kW may be obtained.

By driving 10 km each 10 times on an expressway section, an average discharge power of 50 kW may be obtained, and, by driving 10 km each 10 times on the expressway section, an average charging power of 20 kW may be obtained.

In addition, by driving 1 km each 10 times on a mountain road section, an average discharge power of 40 kW may be obtained, and, by driving 1 km each 10 times on the mountain road section, an average charging power of 30 kW may be obtained.

In the same way at S103, the first controller Ctrl 1 may obtain data on average discharge torque and average charging torque for each driving situation and data on average discharge RPM and average charging RPM for each driving situation.

In addition, these data may be repeated a set number of times (e.g., 10 times).

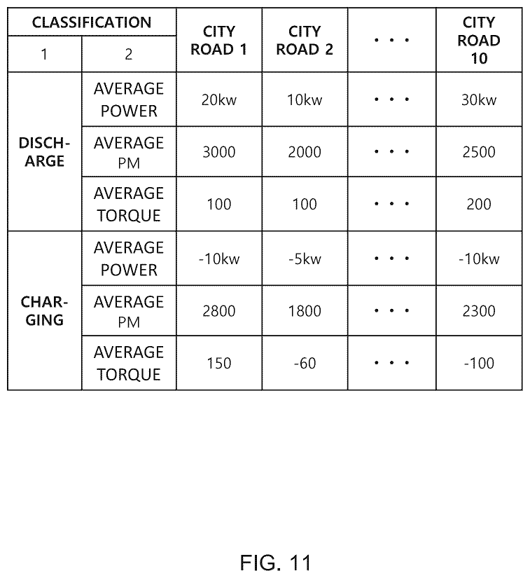

As a result, as shown in FIG. 11, on the city road section, data on average power, data on average RPM, and data on average torque for 10 times may be obtained for discharge and charging.

In FIG. 11, the data on the average discharge power corresponding to “city road 1” may be the average discharge power obtained by driving 2 km each 10 times on a city road section, and the data on the average discharge power corresponding to “city road 2” may be the average discharge power obtained by driving 2 km each 10 times on a city road section or at a time point other than the “city road 1.”

Next, at S104, the first controller Ctrl 1 may standardize the normal distribution of the data obtained in such a way and obtain learning data to be used as reference data based on a set probability.

That is, based on the probability set based on the standard normal distribution, the first controller Ctrl 1 may determine first and second discharge powers, first and second charging powers, first and second discharge torques, first and second charging torques, first and second discharge RPMs, and first and second charging RPMs.

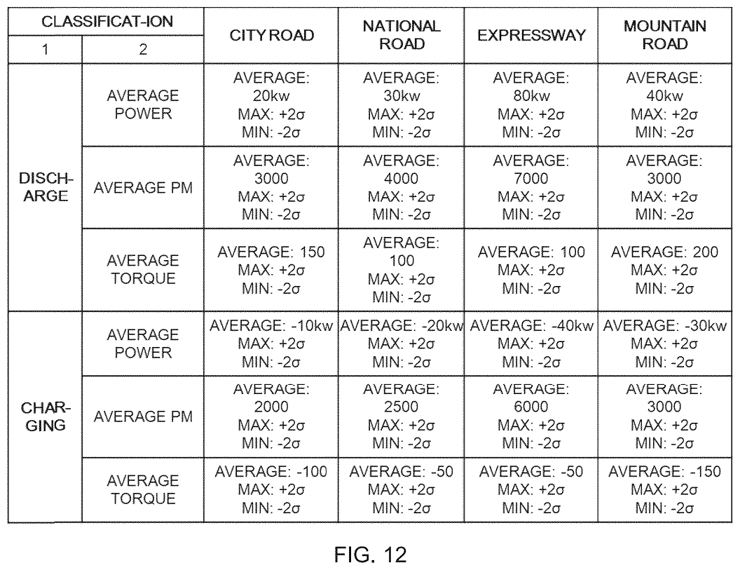

FIG. 12 shows an example of average data obtained by normalizing data for each driving situation and maximum and minimum values thereof determined based on an around 98% probability through the standard normal distribution.

For example, in FIG. 12, the discharge learning data for “city road” may have an average of 20 kW, the maximum value may be obtained by adding a double standard deviation (σ) to the average, and the minimum value may be obtained by subtracting the double standard deviation (σ) from the average. In addition, the first discharge power may be obtained from the maximum value, and the second discharge power may be obtained from the minimum value.

In the meantime, when it is based on an around 99% probability, the original standard deviation (σ) may be applied instead of the double standard deviation (σ).

The learning data for each driving situation in FIG. 12 may be used as reference data, which will be described below. For reference, in FIG. 12, for convenience, the standard deviations for each driving situation are expressed equally as, but it is needless to say that the standard deviation values for each driving situation may be different.

First, taking the learning data for the driving situation corresponding to “city road” among the learning data in FIG. 12 as an example, the first discharge power may be “20 kW+2σ,” the second discharge power may be “20 kW−2σ,” the first discharge RPM may be “3000+2σ,” the second discharge RPM may be “3000−2σ,” the first discharge torque may be “150+2σ,” the second discharge torque may be “150−2σ,” the first charging power may be “−10 kW−2σ,” the second charging power may be “−10 kW+2σ,” the first charging RPM may be “2000+2σ,” the second charging RPM may be “2000−2σ,” the first charging torque may be “−100−2σ,” and the second charging torque may be “−100+2σ.”

The average values in FIG. 12 may be used as reference data for dividing an operation section into multiple areas. For example, each reference line in FIG. 7 may be determined using the average values in FIG. 12.

Taking the driving situation corresponding to “city road” in FIG. 12 as an example, in the case of the discharge, an average power of 20 kW may be “A,” discharge power, in FIG. 7, an average RPM of 3,000 may be “K” in FIG. 7, and an average torque of 150 may be “Tdc” in FIG. 7, and, in the case of the charging, an average power of −10 kW may be “B,” charging power, in FIG. 7, an average RPM of 2,000 may be “K” in FIG. 7, and an average torque of −100 may be “Tc” in FIG. 7.

That is, a operation section may be divided into multiple areas for the discharge and the charging based on the learning data.

When the data in FIG. 12 is applied to a torque-RPM map, an operation section may be divided differently for each driving situation.

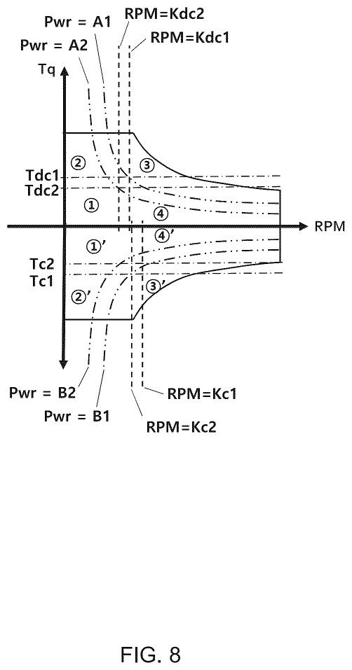

FIG. 8 shows an example of how an operation section is divided based on such learning data.

FIG. 8 shows that, for each reference line (based on the average values in FIG. 12), a hysteresis section in a set range (e.g., ±2σ) may be defined.

In other words, based on the data in FIG. 12, a hysteresis section may be defined by the first discharge power (A1) line, “Pwr=A1,” and the second discharge power (A2) line, “Pwr=A2,” in FIG. 8, a hysteresis section may be defined by the “Tq=Tdc1” and the “Tq=Tdc2” in FIG. 8, and a hysteresis section may be defined by the “RPM=Kdc1” and the “RPM=Kdc2” in FIG. 8. In addition, in the case of the charging, a hysteresis section may be defined by the first charging power (B1) line, “Pwr=B1,” and the second charging power (B2) line, “Pwr=B2,” in FIG. 8, a hysteresis section may be defined by the “Tq=Tc1” and the “Tq=Tc2” in FIG. 8, and a hysteresis section may be defined by the “RPM=Kc1” and the “RPM=Kc2” in FIG. 8.

Referring back to FIG. 3, the first controller Ctrl 1 may determine whether the general mode or the performance mode has been set as a driving mode at S25 and perform control of S30 or S40 depending on the set mode, which will be described below.

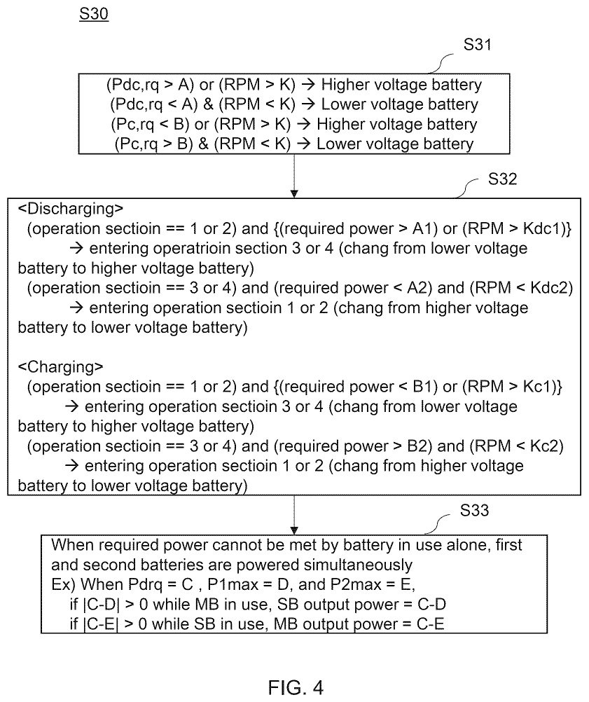

First, the control of battery operation in the general mode (S30) may be performed as shown in FIG. 4.

At S31, the first controller Ctrl 1 may select and use either the first high voltage battery MB or the second high voltage battery SB based on the operation point of the driving motor M, i.e., RPM and power.

As described above, a discharge power (A), a charging power (B), and a reference RPM (K) at S31 may be determined based on learning data as shown in FIG. 12, thereby determining a battery to be used as follows.

The first controller Ctrl 1 may determine, at S31, to use the second high voltage battery SB with a higher voltage when a required power (Pdc, rq) is greater than the discharge power (A).

The first controller Ctrl 1 may determine to use the second high voltage battery SB with a higher voltage when RPM is greater than the reference RPM (K).

The first controller Ctrl 1 may determine to use the first high voltage battery MB with a lower voltage when the required power (Pdc, rq) is less than the discharge power (A) and the RPM is less than the reference RPM (K).

In addition, the first controller Ctrl 1 may determine to use the second high voltage battery SB with a higher voltage when a required power (Pc, rq) of regenerative braking is less than the charging power (B).

During regenerative braking, the first controller Ctrl 1 may determine to use the second high voltage battery SB with a higher voltage when the RPM is greater than the reference RPM (K).

The first controller Ctrl 1 may determine to use the first high voltage battery MB with a lower voltage when the required power (Pc, rq) of regenerative braking is greater than the charging power (B) and the RPM is less than the reference RPM (K).

Meanwhile, the first controller Ctrl 1 may use the hysteresis section when determining the transition between operation sections, and may determine a battery to be used based on the determined transition at S32.

That is, at S32, with the general mode set as a driving mode and the current operation point in the first discharge operation section or the second discharge operation section, when a required power is greater than the first discharge power (A1) or RPM is greater than the first discharge RPM (Kdc1), the first controller Ctrl 1 may determine to use a battery with a higher voltage among the first battery and the second battery.

In this case, with the current operation point in the third discharge operation section or the fourth discharge operation section, when the required power is less than the second discharge power (A2) or the RPM is less than the second discharge RPM (Kdc2), the first controller Ctrl 1 may determine to use a battery with a lower voltage among the first battery and the second battery.

In this case, with the current operation point in the first charging operation section or the second charging operation section, when the required power is less than the first charging power (B1) or the RPM is greater than the first charging RPM (Kc1), the first controller Ctrl 1 may determine to use a battery with a higher voltage.

In addition, in this case, with the current operation point in the third charging operation section or the fourth charging operation section, when the required power is greater than the second charging power (B2) or the RPM is less than the second charging RPM (Kc2), the first controller Ctrl 1 may determine to use a battery with a lower voltage.

Meanwhile, at S33, after either the battery with a higher voltage or the battery with a lower voltage is selected, when the required power cannot be met by the selected battery alone, it may be determined to use the other battery as well.

For example, assuming that a driver's required power (Pdrq) is “C,” the maximum output power (P1max) of the first high voltage battery MB is “D,” and the maximum output power (P2max) of the second high voltage battery SB is “E,” when the maximum output power (P1max) of the first high voltage battery MB is determined to be less than the “C,” the driver's required power (Pdrq), after the first high voltage battery MB has been determined to be used, the second high voltage battery SB may be used to compensate for the shortage (C-D). In addition, in this case, when the maximum output power (P2max) of the second high voltage battery SB is determined to be less than the “C,” the driver's required power (Pdrq), after the second high voltage battery SB has been determined to be used, the first high voltage battery MB may be used to compensate for the shortage (C-E).

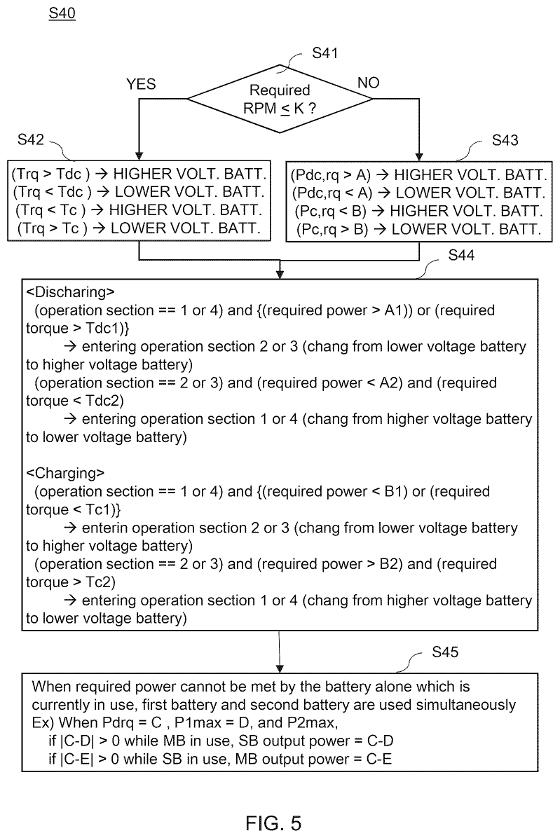

Hereinafter, the control of battery operation in the performance mode (S40) will be described with reference to FIG. 5.

At S41, when RPM is less than or equal to the reference RPM (K) (YES at S41), a torque control mode (S42) may be performed, otherwise (NO at S41), a power control mode (S43) may be performed.

At S42, the first controller Ctrl 1 may determine to use the second high voltage battery SB with a higher voltage when a required torque is greater than the discharge torque (Tdc), and may determine to use the first high voltage battery MB with a lower voltage when the required torque is less than the discharge torque (Tdc).

In addition, the first controller Ctrl 1 may determine to use the second high voltage battery SB with a higher voltage when a required torque of regenerative braking is less than the charging torque (Tc), and may determine to use the first high voltage battery MB with a lower voltage when the required torque of regenerative braking is greater than the charging torque (Tc).

Meanwhile, at S43, the first controller Ctrl 1 may determine to use the second high voltage battery SB with a higher voltage when the required power (Pdc, rq) is greater than the discharge power (A), and may determine to use the first high voltage battery MB with a lower voltage when the required power (Pdc, rq) is less than the discharge power (A).

In addition, the first controller Ctrl 1 may determine to use the second high voltage battery SB with a higher voltage when the required power (Pc, rq) of regenerative braking is less than the charging power (B), and may determine to use the first high voltage battery MB with a lower voltage when the required power (Pc, rq) of regenerative braking is greater than the charging power (B).

In the performance mode as well, the first controller Ctrl 1 may use the hysteresis section when determining the transition between operation sections, and may determine a battery to be used based on the determined transition at S44.

That is, at S44, with the current operation point in the first discharge operation section or the fourth discharge operation section, when the required power of the operation point is greater than the first discharge power (A1) or the required torque is greater than the first discharge torque (Tdc1), the first controller Ctrl 1 may determine to use a battery with a higher voltage.

In this case, with the current operation point in the second discharge operation section or the third discharge operation section, when the required power is less than the second discharge power (A2) and the required torque is less than the second discharge RPM (Kdc2), the first controller Ctrl 1 may determine to use a battery with a lower voltage.

In addition, in this case, with the current operation point in the first charging operation section or the fourth charging operation section, when the required power is less than the first charging power (B1) or the required torque is less than the first charging torque (Tc1), the first controller Ctrl 1 may determine to use a battery with a higher voltage.

Furthermore, in this case, with the current operation point in the second charging operation section or the third charging operation section, when the required power is greater than the second charging power (B2) or the required torque is greater than the second charging torque (Tc2), the first controller Ctrl 1 may determine to use a battery with a lower voltage.

In the performance mode as well, at S45, after either the battery with a higher voltage or the battery with a lower voltage is selected, when the required power cannot be met by the selected battery alone, it may be determined to use the other battery as well. In this embodiment, S45 is identical to S33 described above, so no detailed description thereof will be provided.

Meanwhile, in this embodiment, the general mode may mean a low-power mode and include at least one of a normal mode, a comfort mode, an eco mode, and a smart mode, and the performance mode may be a high-torque mode and include at least one of a sports mode and a track mode.

The normal mode may be, for example, a general driving mode for balancing a vehicle's performance and fuel efficiency.

The comfort mode may be, for example, a mode set for driver comfort related to acceleration, braking, ride quality, etc.

The eco mode may be, for example, a mode for optimizing the fuel efficiency of a vehicle. In the eco mode, acceleration may be slow and the gear ratio of a transmission may be high, so that energy consumption may be relatively reduced. In the eco mode, an air conditioner may be controlled to automatically turn off to reduce electricity usage.

The sports mode may be, for example, a mode for maximizing the performance of a vehicle. In the sports mode, the output of the first driving motor M may be increased and the gear ratio of a transmission may be lowered, allowing the vehicle to accelerate quickly. In addition, in the sports mode, steering assistance may be increased and a suspension system may strengthen, achieve a more agile driving.

The track mode may be a mode designed for driving on a race track, and may be, for example, supported in Tesla vehicles. The track mode may change settings for stability control, traction control, regenerative braking, and a cooling system to improve performance and handling.

A driving mode may be selected by a driver.

In other words, the first controller Ctrl 1 may check whether one of a plurality of driving modes has been selected by the driver.

For example, a driving mode may be selected by a driver's input through an AVN screen or an input means such as a button, a jog stick, or a dial provided in the first mobility device MLT 1.

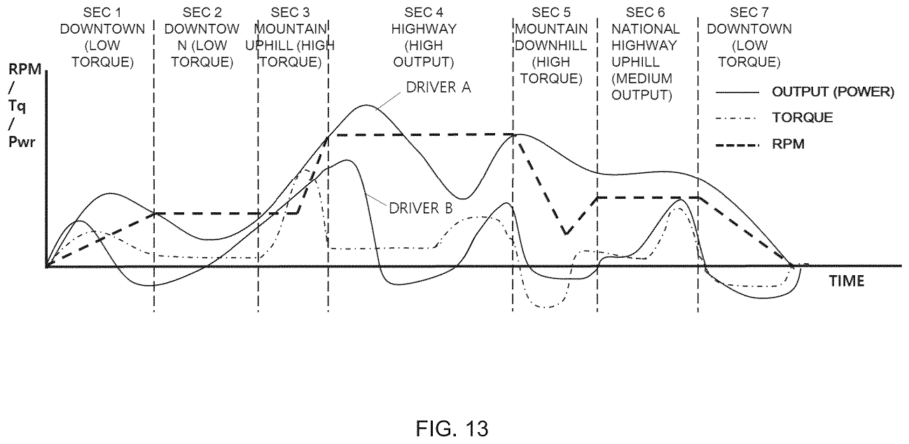

FIG. 13 illustrates a driving simulation according to an embodiment of the present disclosure, which will be described below.

First, FIG. 13 shows the RPM, torque, and power of the first driving motor M over driving time.

Referring to FIG. 13, the first mobility device MLT 1 drives from a first driving section (SEC 1) to a seventh driving section (SEC 7). In the first driving section (SEC 1), the first mobility device MLT 1 drives on a city road with a low torque, and, in a second driving section (SEC 2), it drives on a city road with a low power.

In addition, in a third driving section (SEC 3) in FIG. 13, the first mobility device MLT 1 drives uphill on a mountain road with a high torque, and, in a fourth driving section (SEC 4), it drives on an expressway with a high power.

Furthermore, in a fifth driving section (SEC 5), the first mobility device MLT 1 drives downhill on a mountain road with a high torque regenerative braking, and, in a sixth driving section (SEC 6), it drives uphill on a national road with a medium power.

Finally, in the seventh driving section (SEC 7), the first mobility device MLT 1 drives on a city road with a low torque.

Because a battery is determined based on learning data of each of Driver A and Driver B for such driving situations, their driving results may be different from each other.

That is, as shown in FIG. 13, even when Driver A and Driver B drive on the same driving course, their output power profiles during the drive may be different because their battery operation strategies may be determined based on their respective learning data while they are driving.

The desirable embodiments of the present disclosure have been shown and described, but the present disclosure is not limited to the specific embodiments described above. It is needless to say that various modifications can be made to the present disclosure within the gist of the present disclosure claimed in the appended claims by a person having ordinary skill in the art, and such modifications should not be understood separately from the technology of the present disclosure.

1. A method of controlling a battery of a vehicle including a plurality of wheels, a driving motor configured to supply a driving force to the plurality of wheels, and a controller configured to control power supply to the driving motor or charging by the driving motor, the method comprising:
determining, by the controller, a plurality of operation sections based on reference data including learning data obtained during driving of the vehicle;
selecting, by the controller, one among a first battery or a second battery based on an operation section in which an operation point of the driving motor is among the plurality of operation sections; and
controlling power supply or charging using the selected first or second battery.

2. The method of claim 1, wherein the plurality of operation sections are set according to at least one of an equal power reference line, an equal APS reference line, and an RPM reference line based on the reference data.

3. The method of claim 2, wherein the plurality of operation sections include at least two of:
a first discharge operation section positioned below a discharge RPM reference line and a discharge equal APS reference line;
a second discharge operation section surrounded by a discharge equal power reference line, the discharge equal APS reference line, and a predetermined maximum discharge torque line;
a third discharge operation section determined as positioned above the equal power reference line; and
a fourth discharge operation section determined as positioned above the discharge RPM reference line and below the discharge equal power reference line; or
include at least two of:
a first charging operation section positioned below a charging RPM reference line and above a charging equal APS reference line;
a second charging operation section surrounded by a charging equal power reference line, the charging equal APS reference line, and a predetermined maximum charging torque line;
a third charging operation section determined as positioned below the charging equal power reference line; and
a fourth charging operation section determined as positioned above the charging RPM reference line and the charging equal power reference line.

4. The method of claim 3, wherein the learning data includes power data, torque data, and RPM data.

5. The method of claim 4, wherein the power data includes discharge power data or charging power data, the torque data includes discharge torque data or charging torque data, and the RPM data includes discharge RPM data or charging RPM data.

6. The method of claim 5, wherein the discharge power data includes a first discharge power and a second discharge power, the charging power data includes a first charging power and a second charging power, the discharge torque data includes a first discharge torque and a second discharge torque, the charging torque data includes a first charging torque and a second charging torque, the discharge RPM data includes a first discharge RPM and a second discharge RPM, or the charging RPM data includes a first charging RPM and a second charging RPM.

7. The method of claim 6, wherein, when a general mode is set as a driving mode, selecting one battery includes at least one of:
selecting a battery of a higher voltage among the first battery and the second battery as the one battery when a current operation point is in the first discharge operation section or the second discharge operation section, and a required power of the operation point is greater than the first discharge power or RPM of the operation point is greater than the first discharge RPM;
selecting a battery of a lower voltage among the first battery and the second battery as the one battery when the current operation point is in the third discharge operation section or the fourth discharge operation section, and the required power is less than the second discharge power and the RPM is less than the second discharge RPM;
selecting the battery of the higher voltage as the one battery when the current operation point is in the first charging operation section or the second charging operation section, and the required power is less than the first charging power or the RPM is greater than the first charging RPM; and
selecting the battery of the lower voltage as the one battery when the current operation point is in the third charging operation section or the fourth charging operation section, and the required power is greater than the second charging power and the RPM is less than the second charging RPM.

8. The method of claim 7, wherein the general mode includes at least one of a normal mode, a comfort mode, or an eco mode.

9. The method of claim 6, wherein, when a performance mode is set as a driving mode, selecting one battery includes at least one of:
selecting a battery of a higher voltage among the first battery and the second battery as the one battery when a current operation point is in the first discharge operation section or the fourth discharge operation section, and a required power of the operation point is greater than the first discharge power or a required torque of the operation point is greater than the first discharge torque;
selecting a battery of a lower voltage among the first battery and the second battery as the one battery when the current operation point is in the second discharge operation section or the third discharge operation section, and the required power is less than the second discharge power and the required torque is less than the second discharge RPM selecting the battery of the higher voltage as the one battery when the current operation point is in the first charging operation section or the fourth charging operation section, and the required power is less than the first charging power or the required torque is less than the first charging torque; and
selecting the battery of the lower voltage as the one battery when the current operation point is in the second charging operation section or the third charging operation section, and the required power is greater than the second charging power and the required torque is greater than the second charging torque.

10. The method of claim 9, wherein the performance mode includes at least one of a sports mode or a track mode.

11. The method of claim 6, further comprising:
obtaining data on power, torque, and RPM for a predetermined driving distance for each driving situation and determining averages thereof, repeatedly for a predetermined number of times;
applying a standardized normal distribution for the averages; and
determining, based on a set probability, at least one set of: the first discharge power and the second discharge power; the first charging power and the second charging power; the first discharge torque and the second discharge torque; the first charging torque and the second charging torque; the first discharge RPM and the second discharge RPM; or the first charging RPM and the second charging RPM.

12. The method of claim 11, further comprising:
determining a set of the first discharge power and the second discharge power or the first charging power and the second charging power based on an average and a standard deviation of data on power among the averages;
determining the first discharge torque and the second discharge torque or the first charging torque and the second charging torque based on an average and a standard deviation of data on torque among the averages; or
determining the first discharge RPM and the second discharge RPM or the first charging RPM and the second charging RPM based on an average and a standard deviation of data on RPM among the averages.

13. The method of claim 1, further comprising determining that the second battery is detachably connected and added to a power system including the first battery.

14. A vehicle controller comprising:
a memory storing computer-executable instructions; and
one or more processors configured to access the memory and execute the instructions,
wherein the instructions comprise:
determining a plurality of operation sections based on reference data including learning data obtained during driving of the vehicle;
selecting one among a first battery or a second battery based on an operation section in which an operation point of a driving motor is among the plurality of operation sections; and
controlling power supply or charging using the selected first or second battery.

15. An electric vehicle comprising:
a plurality of wheels;
a driving motor supplying a driving force to the plurality of wheels; and
a controller including a memory storing computer-executable instructions and one or more processors configured to access the memory and execute the instructions to control power supply to the driving motor or charging by the driving motor,
wherein the instructions comprise:
determining a plurality of operation sections based on reference data including learning data obtained during driving of the vehicle;
selecting one among a first battery or a second battery based on an operation section in which an operation point of the driving motor is among the plurality of operation sections; and
controlling the power supply or the charging using the selected first or second battery.

16. The electric vehicle of claim 15, wherein the plurality of operation sections are set according to at least one of an equal power reference line, an equal APS reference line, and an RPM reference line based on the reference data.

17. The electric vehicle of claim 16, wherein the plurality of operation sections include at least two of:
a first discharge operation section positioned below a discharge RPM reference line and a discharge equal APS reference line;
a second discharge operation section surrounded by a discharge equal power reference line, the discharge equal APS reference line, and a predetermined maximum discharge torque line;
a third discharge operation section determined as positioned above the equal power reference line; and
a fourth discharge operation section determined as positioned above the discharge RPM reference line and below the discharge equal power reference line; or
include at least two of:
a first charging operation section positioned below a charging RPM reference line and above a charging equal APS reference line;
a second charging operation section surrounded by a charging equal power reference line, the charging equal APS reference line, and a predetermined maximum charging torque line;
a third charging operation section determined as positioned below the charging equal power reference line; and
a fourth charging operation section determined as positioned above the charging RPM reference line and the charging equal power reference line.

18. The electric vehicle of claim 17, wherein the learning data includes power data, torque data, and RPM data.

19. The electric vehicle of claim 18, wherein the power data includes discharge power data or charging power data, the torque data includes discharge torque data or charging torque data, and the RPM data includes discharge RPM data or charging RPM data.

20. The electric vehicle of claim 19, wherein the discharge power data includes a first discharge power and a second discharge power, the charging power data includes a first charging power and a second charging power, the discharge torque data includes a first discharge torque and a second discharge torque, the charging torque data includes a first charging torque and a second charging torque, the discharge RPM data includes a first discharge RPM and a second discharge RPM, or the charging RPM data includes a first charging RPM and a second charging RPM.
